(19) United States
(12) Patent Application Publication
(10) Pub. No.: US 2012/0110741 A1
(43) Pub. Date: May 10, 2012

(54) WRAP AROUND FOOT PANEL

(76) Inventors: Brian E. Mears, Batesville, IN (US); Jonathan D. Turner, Dillsboro, IN (US)

(21) Appl. No.: 12/939,213

(22) Filed: Nov. 4, 2010

(51) Int. Cl. A61G 7/015; A47C 21/08; A61G 7/05

(52) U.S. Cl. 5/618; 5/624

(57) ABSTRACT

A patient support apparatus is movable between a conventional bed position, having a generally horizontal sleeping surface, and a chair egress position, allowing a patient to exit the support from a sitting position. The patient support comprises a deck and a foot panel removably coupled to the deck. The foot panel is configured to reduce tipping moments applied to cantilevered portions of the deck while the patient support apparatus is in the conventional bed position.

### BACKGROUND

The present disclosure relates to a patient support apparatus, such as a hospital bed, for supporting a patient. Particularly, the present disclosure relates to a foot panel configured to reduce and oppose tipping moments applied to cantilevered portions of the patient support surface while the bed is in the conventional bed position.

Hospital beds known in the art are configured to move between a conventional bed position, wherein the patient support surface is generally flat, and a chair egress position, wherein the foot-end of the patient support surface is lowered so that a patient can egress or exit the bed from a sitting position. In order to allow the patient support surface to articulate into a chair egress position, the foot-end of the support surface often extends away from a supporting base while the patient support apparatus is in the conventional bed position. When a patient enters or exits the patient support apparatus on the cantilevered portion of the patient support surface, a tipping moment is created encouraging the hospital bed to tip toward the foot-end of the bed.

In the prior art, opposition to tipping has been accomplished by increasing the mass of the supporting base or by locating ballast at the head-end of hospital beds.

### SUMMARY

The present application discloses one or more of the features recited in the appended claims and/or the following features which, alone or in any combination, may comprise patentable subject matter.

In one aspect of the present disclosure, a patient support apparatus includes a deck having a head-end and a foot-end, first and second siderails positioned on lateral sides of the deck, and a foot panel removably coupled to the deck. The foot panel includes a foot panel body adjacent the foot-end of the deck and a first sidearm, extending generally perpendicularly from the foot panel body toward the head-end of the deck and coupled to the foot panel body, the first sidearm establishing a barrier adjacent the foot panel.

In some embodiments, the patient support apparatus may include a mattress assembly supported on the deck. In some such embodiments, the foot panel body and first sidearm may extend above a top surface of the mattress assembly and the patient support apparatus may be movable between a position wherein the deck forms a generally flat surface and a chair egress position.

It is also contemplated that the foot panel further may further include a curved shoulder situated between interposed between the foot panel body and the first sidearm. Also, the first sidearm is formed to include handholds.

In some embodiments, the foot panel may include a second sidearm spaced apart from the first sidearm and extending generally perpendicularly from the foot panel body toward the head-end of the deck. The second sidearm may be coupled to the foot panel body and may be formed to include handholds.

The patient support apparatus may further have a base and a first siderail. The first siderail may be spaced apart from the first sidearm. In such embodiments, the base may be configured to act as a support for the foot-end of the deck and the foot-end of the deck may extend beyond the support of the base. The foot-end of the first siderail and the head-end of the first sidearm may define a loading zone.

It is contemplated that the foot panel may be coupled to the deck by a coupler configured to be switched between a locked condition, preventing detachment of the foot panel from the deck, and an unlocked condition, allowing detachment of the foot panel from the deck. In such embodiments, the coupler may be switched between the locked and the unlocked condition by an instrument.

In another aspect of the present disclosure, a patient support apparatus includes a deck having a head-end and a foot-end spaced apart from the head-end and a foot panel removably coupled to the deck including a unitarily formed foot panel body extending along the foot-end of the deck and sidearm. The sidearm extends generally perpendicularly away from the foot panel body along a portion of the deck and extends above the top surface of the mattress assembly.

In some embodiments, the sidearm may have an upper sidearm cutout and a lower sidearm cutout such that the sidearm extends generally perpendicularly from the foot panel body over only a portion of the vertical height of the foot panel body. The foot panel may further have a curved shoulder, unitarily formed with the foot panel body and sidearm, and interposed between the foot panel body and sidearm. It is contemplated that the foot panel body may extend along substantially the entire length of the foot-end of the deck and may extend above a top surface of the mattress assembly.

In yet another aspect of the present disclosure, a patient support apparatus includes a deck having a head-end and a foot-end, and a foot panel removably coupled to the deck. The deck includes a foot panel body extending along substantially the entire length of the foot-end of the deck, a first sidearm, extending generally perpendicularly from the foot panel body, along an edge of the deck, toward the head-end of the deck and coupled to the foot panel body, and a second sidearm, extending generally perpendicularly from the foot panel body, along an edge of the deck, toward the head-end of the deck and coupled to the foot panel body.

It is contemplated that the foot panel may further have a first sidearm extender and a second sidearm extender coupled to the first sidearm and the second sidearm, respectively. The patient support apparatus may include a mattress assembly supported on the deck and the first and the second sidearm extenders may extend above the top surface of the mattress assembly.

In some embodiments, the first and the second sidearm extenders are configured to slide generally perpendicularly to the foot panel body along an edge of the deck. The first and the second sidearm extenders may be stowable within the first and the second sidearms, respectively.

The patient support apparatus further may include a base, a first siderail, and a second siderail. The first and the second siderails may extend along the deck and may be spaced apart from and generally parallel to the first and the second sidearms, respectively. The base may be configured to act as a support for the deck and the foot-end of the deck may extend beyond the support of the base. The foot-end of the first and the second siderails and the head-end of the first and the second sidearm extenders may define a loading zone.

It is contemplated that the foot panel may be coupled to the deck by a coupler configured to be switched between a locked condition, preventing detachment of the foot panel from the deck, and an unlocked condition, allowing detachment of the foot panel from the deck. In some such embodiments, the coupler may be switched between the locked and the unlocked condition by an instrument.

Additional features, which alone or in combination with any other feature(s), including those listed above, those listed in the claims, and those described in detail below, may comprise patentable subject matter. Other features will become apparent to those skilled in the art upon consideration of the following detailed description of illustrative embodiments exemplifying the best mode of carrying out the invention as presently perceived

### BRIEF DESCRIPTION OF THE DRAWINGS

The detailed description particularly refers to the accompanying figures, in which:

FIG. 1 is a perspective view of a chair bed in a conventional bed position and including a foot panel coupled to a foot-end of a deck of the chair bed;

FIG. 2 is a perspective view of the foot panel of FIG. 1 removed from the chair bed;

FIG. 3 is a side view of the chair bed of FIG. 1 in a conventional bed position;

FIG. 4 is a perspective view of a chair bed showing the chair bed in a conventional bed position and including an another embodiment foot panel of the chair bed in FIGS. 1, 2, and 3; and

FIG. 5 is a top view of the chair bed in a conventional bed position and including another embodiment foot panel of the chair bed in FIGS. 1, 2, and 3.

### DETAILED DESCRIPTION OF THE DRAWINGS

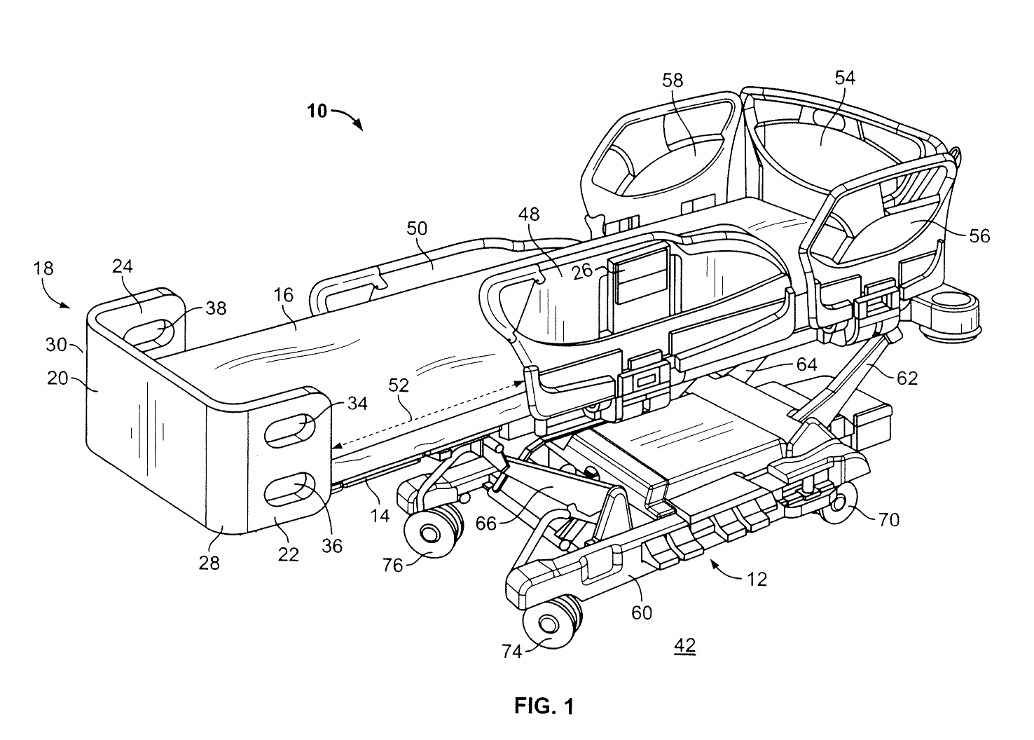

A patient support apparatus illustratively embodied as a hospital bed 10 comprises a base 12, a deck 14, and a mattress assembly 16 as shown in FIG. 1. The deck 14 is supported by the base 12 and extends beyond the base 12 at a foot-end of the deck 14. The deck 14 supports the mattress assembly 16. The bed 10 is movable between a conventional bed position, wherein the deck 14 is generally flat, and a chair egress position (not shown), wherein the deck 14 is articulated so that the patient support apparatus 10 is configured to allow a patient to egress or exit the bed 10 from a sitting position.

The bed 10 further includes a foot panel 18 that is removably coupled to the foot-end of the deck 14. The foot panel 18 includes a foot panel body 20, a first foot panel sidearm 22 and a second foot panel sidearm 24. The foot panel 18 includes a first foot panel shoulder 28 and a second foot panel shoulder 30. As discussed in greater detail below, the foot panel 18 reduces a tipping moment created by a patient force 32 applied to the cantilevered portion of deck 14.

The foot panel body 20 extends along the foot-end of the deck 14. The foot panel body 20 also extends above the top surface of the mattress assembly 16, when the mattress assembly 16 is present. The foot panel body 20 is unitarily formed with the first and the second foot panel sidearms 22, 24. The first and the second foot panel shoulders 28, 30, are curved. The foot panel shoulders 28, 30, are unitarily formed with the foot panel body 20 and the first and the second foot panel sidearms 22, 24. In other embodiments (not shown), the first and the second foot panel sidearms 22, 24, are coupled by fasteners to the foot panel body 20.

The first and the second foot panel sidearms 22, 24, extend generally perpendicularly from the foot panel body 20 along opposing sides of the deck 14. Additionally, both the first and the second foot panel sidearms 22, 24, extend above the top surface of the mattress assembly 16, when the mattress assembly 16 is present. The first foot panel sidearm 22 includes a first and a second sidearm void 34, 36. The second foot panel sidearm 24 also includes a first and a second sidearm void 38, 40. The first and the second foot panel sidearm voids 34, 36, 38, 40, provide handholds for easier manipulation of the foot panel 18.

The bed 10 also includes a first siderail 48 and a second siderail 50. The first and the second siderails 48, 50, are spaced apart from the first and the second foot panel sidearms 22, 24, and extend generally perpendicularly to the foot panel body 20, along the deck 14. The first and the second siderails 48, 50, extend above the top surface of the mattress assembly 16, when the mattress assembly 16 is present, and are adjustable across a predetermined range of heights.

The bed 10 also includes a head panel 54, a first headrail 56, and a second headrail 58. The head panel 54 extends along the head-end of the deck 14. The head panel 54 is removable from the bed 10. The first and the second headrails 56, 58, are adjacent to the head panel 54, and extend generally perpendicularly to the head panel 54, along the deck 14. The first and the second headrails 56, 58, extend above the top surface of the mattress assembly 16, when the mattress assembly 16 is present, and are adjustable across a predetermined range of heights. The head panel 54 and the first and the second headrails 56, 58, block patient entry egress near the head-end of the bed 10.

The head-end of the first and the second foot panel sidearms 22, 24, define the foot-end of a loading zone 52. The foot-end of the first and the second siderails 48, 50, define the head-end of the loading zone 52. In other embodiments and configurations, such as when the first and the second siderails 48, 50, are removed, the head-end of the loading zone 52 is defined by the foot-end of the first and the second headrails 54, 56 or by the head-end of the bed 10. The loading zone 52 is suitable for patient entry to, and egress from, the bed 10 when the bed 10 is in conventional bed position. Additionally, the loading zone 52 includes a portion of the deck 14 extending beyond the base 12 at the foot-end of the deck 14.

The base 12 includes a base frame 60, a first and a second head-end strut 62, 64, a first and a second foot-end strut 66, 68, a first and a second head-end caster 70, 72, and a first and a second foot-end caster 74, 76. The first and the second head-end struts 62, 64, are coupled to the head-end of base frame 60 and to the deck 14 near the head-end of the deck 14. The first and the second foot-end struts 66, 68, are coupled to the foot-end of the base frame 60 and to the deck 14 such that the foot-end of the deck 14 is cantilevered over the base 12. The first and the second head-end casters 70, 72, are coupled to the base frame 60 near the head-end of the base frame 60 and engage the floor 42. The first and the second foot-end casters 74, 76, are coupled to the base frame 60 near the foot-end of the base frame 60 and engage the floor 42. The first and the second foot-end casters 74, 76, also define a pivot point 78.

The patient force 32 applied in the loading zone 52 at the foot-end of loading zone 52 maximizes the tipping moment about pivot point 78. A maximum loading zone distance 80 is defined by the distance between the pivot point 78 and the foot-end of the loading zone 52. The gravitational moment about the pivot point 78 is determined by multiplying a central gravitational force 82 applied by a constant distance 84 between the central gravitational force 82 and the pivot point 78. The foot panel 18 prevents tipping of the bed 10 by reducing the tipping moment about pivot point 78. The foot panel 18 reduces the tipping moment about pivot point 78 by reducing the maximum loading zone distance 80 with the foot panel sidearms 22, 24. Thus, the foot panel 18 reduces the tipping moment created by the patient force 32 applied to the cantilevered portion of deck 14.

The foot panel 18 is coupled to the deck 14 by a coupler 86. The coupler 86 is movable between a locked position, preventing removal of the foot panel 18, and an unlocked position, allowing removal of the foot panel 18. An instrument 88 is required to move the coupler 86 from the locked position to the unlocked position. Keys, standard tools, and custom tools are contemplated as potential instruments 88 for changing the coupler 86 position. Further, other items such as writing pens, coins, identification badges, electronic key fobs, and the like are also contemplated as potential instruments 88 for changing the coupler 86 position. In other embodiments, the coupler is moved between the locked to the unlocked positions by a caregiver selecting an icon corresponding with the desired position from a graphic user interface 26. The coupler 86 in a locked configuration prevents unwanted de-coupling or manipulation of the foot panel 18.

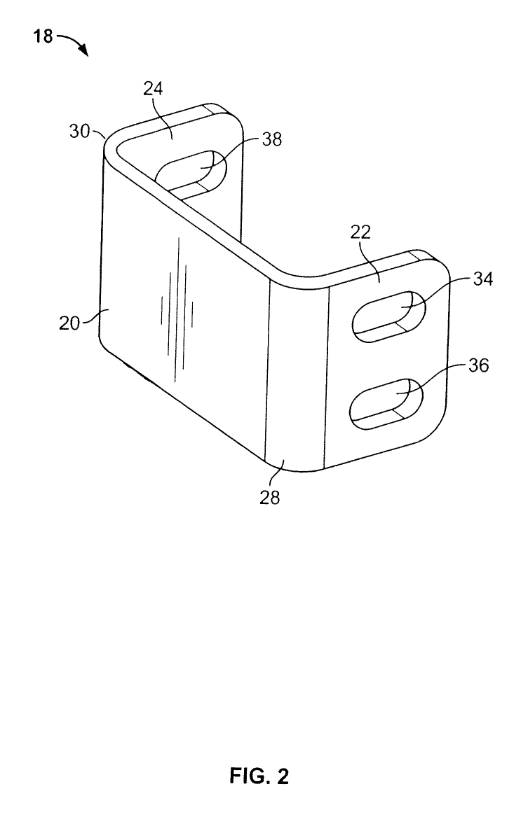

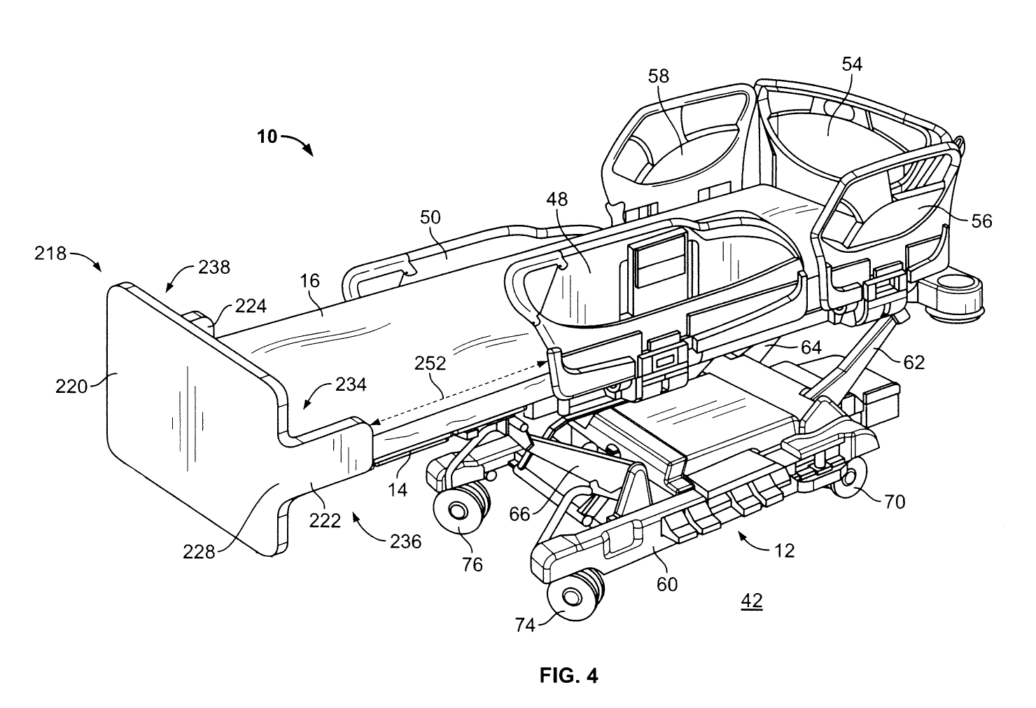

The bed 10 is shown in FIG. 4 with an alternative foot panel embodiment (hereinafter referenced as foot panel 218). Some features of the embodiment illustrated in FIG. 4 are substantially similar to those discussed above in reference to the embodiment of FIGS. 1-3. Such features are designated in FIG. 4 with the same reference numbers as those used in FIGS. 1-3.

The bed 10 includes a foot panel 218 that is removably coupled to the foot-end of the deck 14. The foot panel 218 includes a foot panel body 220, a first foot panel side arm 222, and a second foot panel sidearm 224. The foot panel 218 also includes a first foot panel shoulder 228 and a second foot panel shoulder 230.

The foot panel body 220 is situated beside and extends along the foot-end of the deck 14. The foot panel body 220 also extends above the top surface of the mattress assembly 16, when the mattress assembly 16 is present. The foot panel body 220 extends above the top surfaces and below the bottom surfaces of the first and the second foot panel sidearms 222, 224. The foot panel body 220 is unitarily formed with the first and the second foot panel sidearms 222, 224. The first and the second foot panel shoulders 228, 230, are curved. The foot panel shoulders 228, 230, are unitarily formed with the foot panel body 220 and the first and the second foot panel sidearms 222, 224. In other embodiments, the foot panel sidearms 222, 224, are coupled to the foot panel body 220 by fasteners.

The first and the second foot panel sidearms 222, 224, extend generally perpendicularly from the foot panel body 220 along opposing sides of the deck 14. Additionally, both the first and the second foot panel sidearms 222, 224, extend above the top surface of the mattress assembly 16, when the mattress assembly 16 is present. The first foot panel sidearm 222 includes a first and a second sidearm cutout 234, 236. The second foot panel sidearm 224 also includes a first and a second sidearm cutout 238, 240. The first and the second foot panel sidearm cutouts 234, 236, 238, 240, allow easier manipulation of the foot panel 218.

The bed 10 also includes a first siderail 48 and a second siderail 50. The first and the second siderails 48, 50, are spaced apart from the first and the second foot panel sidearms 222, 224, and extend generally perpendicularly to the foot panel body 220, along the deck 14. The first and the second siderails 48, 50, also extend above the top surface of the mattress assembly 16, when the mattress assembly 16 is present, and are adjustable across a predetermined range of heights.

The bed 10 also includes a head panel 54, a first headrail 56, and a second headrail 58. The head panel 54 extends along the head-end of the deck 14. The head panel 54 is removable from the bed 10. The first and the second headrails 56, 58, are adjacent to the head panel 54, and extend generally perpendicularly to the head panel 54, along the deck 14. The first and the second headrails 56, 58, extend above the top surface of the mattress assembly 16, when the mattress assembly 16 is present, and are adjustable across a predetermined range of heights. The head panel 54 and the first and the second headrails 56, 58, block patient entry and egress near the head-end of the bed 10.

The head-end of the first and the second foot panel sidearms 222, 224, define the foot-end of a loading zone 252. The foot-end of the first and the second siderails 48, 50, define the head-end of the loading zone 252. In other embodiments and configurations, such as when the first and the second siderails 48, 50 are removed, the head-end of the loading zone 252 is defined by the foot-end of the first and the second headrails 54, 56 or by the head-end of the bed 10.

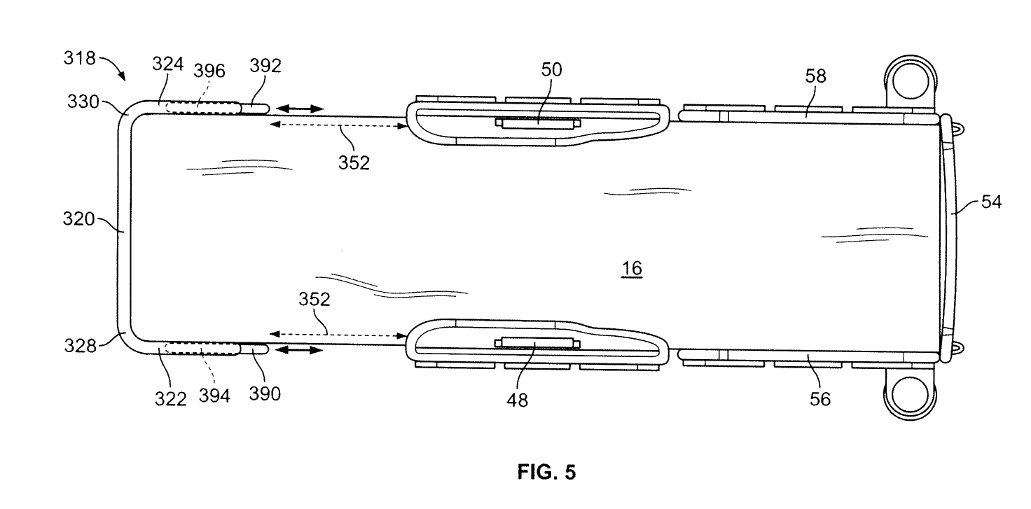

The bed 10 is shown in FIG. 5 with another foot panel embodiment (hereinafter referenced as foot panel 318). Some features of the embodiment illustrated in FIG. 5 are substantially similar to those discussed above in reference to the embodiment of FIGS. 1-3. Such features are designated in FIG. 5 with the same reference numbers as those used in FIGS. 1-3.

The bed 10 includes a foot panel 318 that is removably coupled to the foot-end of the deck 14. The foot panel 318 includes a foot panel body 320 and a first and a second foot panel sidearm 322, 324. The foot panel 318 also includes a first and a second foot panel shoulder 328, 330.

The foot panel body 320 is situated beside and extends along the foot-end of the deck 14. The foot panel body 320 also extends above the top surface of the mattress assembly 16, when the mattress assembly 16 is present. The foot panel body 320 is unitarily formed with the first and the second foot panel sidearms 322, 324. The first and the second foot panel shoulders 328, 330, are curved. The foot panel shoulders 328, 330, are also unitarily formed with the foot panel body 320 and the first and the second foot panel sidearms 322, 324.

The first and the second foot panel sidearms 322, 324, extend generally perpendicularly from the foot panel body 320 along opposing sides of the deck 14. Additionally, both the first and the second foot panel sidearms 322, 324, extend above the top surface of the mattress assembly 16, when the mattress assembly 16 is present. The first and the second foot panel sidearms 322, 324, include a first and a second foot panel extender 390, 392, and a first and a second foot panel extender slot 394, 396. The first and the second foot panel extender slots 394, 396, form an opening on the head-end surface of the first and the second foot panel sidearms 322, 324. The first and the second foot panel extenders 390, 392, are configured to be stored within the first and the second foot panel extender slots 394, 396, respectively. The first and the second foot panel extenders 390, 392, are further configured to move along the edges of the deck 14.

The bed 10 also includes a first siderail 48 and a second siderail 50. The first and the second siderails 48, 50, are spaced apart from the first and the second foot panel sidearms 322, 324, and extend generally perpendicularly to the foot panel body 320, along the deck 14. The first and the second siderails 48, 50, extend above the top surface of the mattress assembly 16, when the mattress assembly 16 is present, and are be adjustable across a predetermined range of heights.

The bed 10 also includes a head panel 54, a first headrail 56, and a second headrail 58. The head panel 54 extends along the head-end of the deck 14. The head panel 54 is removable from the bed 10. The first and the second headrails 56, 58, are adjacent to the head panel 54, and extend generally perpendicularly to the head panel 54, along the deck 14. The first and the second headrails 56, 58, extend above the top surface of the mattress assembly 16, when the mattress assembly 16 is present, and are adjustable across a predetermined range of heights. Also, the first and the second headrails 56, 58, are removable from the bed 10. The head panel 54 and the first and the second headrails 56, 58, block patient entry and egress near the head-end of the bed 10.

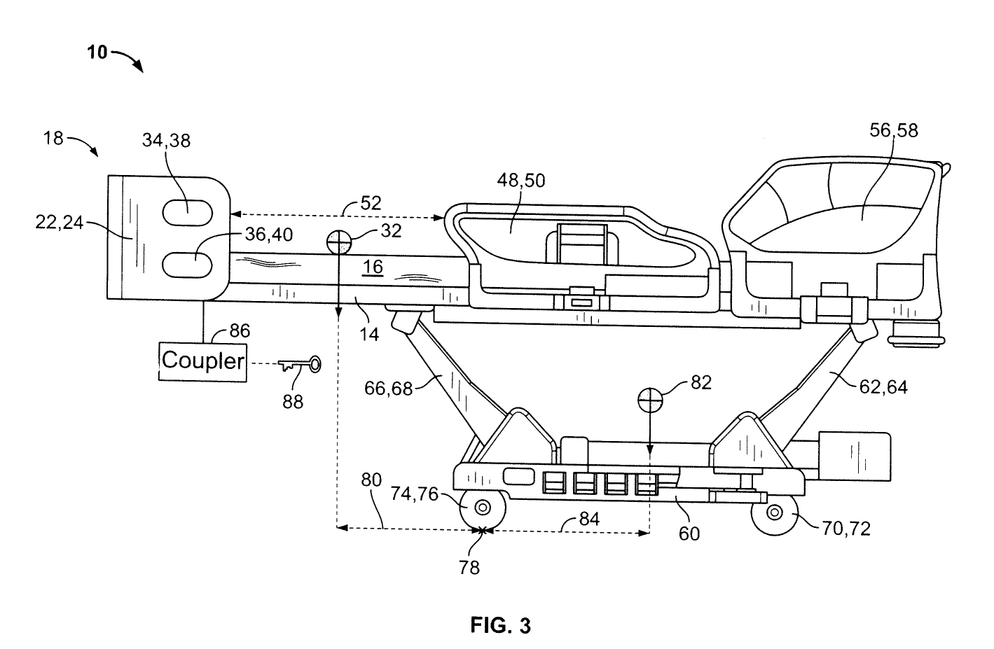

The head-end of the first and the second foot panel extenders 390, 392, define the foot-end of a loading zone 352. The foot-end of the first and the second siderails 48, 50, define the head-end of the loading zone 352. In other embodiments and configurations, such as when the first and the second siderails 48, 50, are removed, the head-end of the loading zone 352 is defined by the foot-end of the first and the second headrails 54, 56 or by the head-end of the bed 10. Since the head-end of the first and the second foot panel extenders 390, 392, are movable relative the head-end of the first and the second foot panel sidearms 322, 324, the maximum loading zone distance 80 (shown in FIG. 3) is variable. Consequently, the maximum tipping moment defined by the maximum loading zone distance 80 and a patient force 32 is also variable. Therefore, by extending the first and the second foot panel extenders 390, 392, as far from the first and the second sidearm as possible 322, 324, the maximum loading zone distance and the maximum tipping moment may be reduced. Additionally, by retracting the first and the second foot panel extenders 390, 392, as far into the first and the second sidearm as possible 322, 324, the maximum loading zone distance and the maximum tipping moment may be increased.

A caregiver may consider, among other factors, patient weight which is likely to contribute to patient force 32 when placing the first and the second foot panel extenders 390, 392. When a patient force 32 is expected to be large, a caregiver can extend the first and the second foot panel extenders 390, 392, in order to reduce the maximum tipping moment that is applied to the bed 10. When a patient force 32 is expected to be small, a caregiver can retract the first and the second foot panel extenders 390, 392, to provide a larger loading zone 352 for use by a patient entering or exiting the bed 10 when the deck 14 is in the conventional bed position.

Although certain illustrative embodiments have been described in detail above, variations and modifications exist within the scope and spirit of this disclosure as described and as defined in the following claims.

1. A patient support apparatus comprising
a deck having a head-end and a foot-end;
first and second siderails positioned on lateral sides of the deck; and
a foot panel removably coupled to the deck, the foot panel including (i) a foot panel body adjacent the foot-end of the deck, and (ii) a first sidearm, extending generally perpendicularly from the foot panel body toward the head-end of the deck and coupled to the foot panel body, the first sidearm establishing a barrier adjacent the foot panel.

2. The patient support apparatus of claim 1, the patient support apparatus further comprises a mattress assembly supported on the deck and the foot panel body and first sidearm extend above a top surface of the mattress assembly; and wherein the patient support apparatus is movable between a position wherein the deck forms a generally flat surface and a chair egress position.

3. The patient support apparatus of claim 2, wherein foot panel further includes a curved shoulder situated between interposed between the foot panel body and the first sidearm.

4. The patient support apparatus of claim 3, wherein the first sidearm is formed to include handholds.

5. The patient support apparatus of claim 4, wherein the foot panel includes a second sidearm spaced apart from the first sidearm extending generally perpendicularly from the foot panel body toward the head-end of the deck; the second sidearm coupled to the foot panel body and formed to include handholds.

6. The patient support apparatus of claim 2, wherein the patient support apparatus further comprises a base and a first siderail, the first siderail spaced apart from the first sidearm, the base configured to act as a support for the foot-end of the deck, the foot-end of the deck extending beyond the support of the base; the foot-end of the first siderail and the head-end of the first sidearm defining a loading zone.

7. The patient support apparatus of claim 1, wherein the foot panel is coupled to the deck by a coupler configured to be switched between a locked condition, preventing detachment of the foot panel from the deck, and an unlocked condition, allowing detachment of the foot panel from the deck.

8. The patient support apparatus of claim 7, wherein the coupler is switched between the locked and the unlocked condition by an instrument.

9. A patient support apparatus comprising:
a deck having a head-end and a foot-end spaced apart from the head-end; and
a foot panel removably coupled to the deck including a unitarily formed foot panel body extending along the foot-end of the deck and sidearm;
wherein the sidearm extends generally perpendicularly away from the foot panel body along a portion of the deck and extends above the top surface of the mattress assembly.

10. The patient support apparatus of claim 9, wherein the sidearm comprises an upper sidearm cutout and a lower sidearm cutout such that the sidearm extends generally perpendicularly from the foot panel body over only a portion of the vertical height of the foot panel body.

11. The patient support apparatus of claim 10, wherein the foot panel further comprises a curved shoulder, unitarily formed with the foot panel body and sidearm, and interposed between the foot panel body and sidearm.

12. The patient support apparatus of claim 9, wherein the foot panel body extends along substantially the entire length of the foot-end of the deck and extends above a top surface of the mattress assembly.

13. A patient support apparatus comprising
a deck having a head-end and a foot-end, and
a foot panel removably coupled to the deck including (i) a foot panel body extending along substantially the entire length of the foot-end of the deck, (ii) a first sidearm, extending generally perpendicularly from the foot panel body, along an edge of the deck, toward the head-end of the deck and coupled to the foot panel body, and (iii) a second sidearm, extending generally perpendicularly from the foot panel body, along an edge of the deck, toward the head-end of the deck and coupled to the foot panel body.

14. The patient support apparatus of claim 13, wherein the foot panel further comprises a first sidearm extender and a second sidearm extender coupled to the first sidearm and the second sidearm, respectively.

15. The patient support apparatus of claim 14, wherein the patient support apparatus further includes a mattress assembly supported on the deck and the first and the second sidearm extenders extend above the top surface of the mattress assembly.

16. The patient support apparatus of claim 14, wherein the first and the second sidearm extenders are configured to slide generally perpendicularly to the foot panel body along an edge of the deck.

17. The patient support apparatus of claim 16, wherein the first and the second sidearm extenders are stowable within the first and the second sidearms, respectively.

18. The patient support apparatus of claim 17, wherein the patient support apparatus further comprises a base, a first siderail, and a second siderail; the first and the second siderails extending along the deck, spaced apart from and generally parallel to the first and the second sidearms, respectively; the base is configured to act as a support for the deck; the foot-end of the deck extending beyond the support of the base; the foot-end of the first and the second siderails and the head-end of the first and the second sidearm extenders defining a loading zone.

19. The patient support of claim 13, wherein the foot panel is coupled to the deck by a coupler configured to be switched between a locked condition, preventing detachment of the foot panel from the deck, and an unlocked condition, allowing detachment of the foot panel from the deck.

20. The patient support apparatus of claim 19, wherein the coupler is switched between the locked and the unlocked condition by an instrument.
